(19) United States
(12) Patent Application Publication
(10) Pub. No.: US 2024/0225928 A9
(43) Pub. Date: Jul. 11, 2024

(54) Portable wheelchair propelling device powered by patients' arm (or arms) pulling on handles instead of turning the wheels

(71) Applicant: Malcolm Rosenberg, Aurora, CO (US)

(72) Inventor: Malcolm Rosenberg, Aurora, CO (US)

(21) Appl. No.: 18/049,430

(22) Filed: Oct. 25, 2022

(51) Int. Cl. A61G 5/02

(52) U.S. Cl. CPC A61G 5/025; A61G 5/021; A61G 5/1013

(57) ABSTRACT

This wheelchair propulsion and steering device enables wheelchair individuals with only one functional arm to drive a wheelchair. Further it enables two handed people stronger and better controlled use of a wheelchair.

### BACKGROUND OF THE DISCLOSURE

### Technical Field of the Disclosure

The present disclosure relates to wheelchairs and more particularly to the propulsion and steering by people with the use of only one arm or people with limited use of both arms.

### Description of the Related Art

Wheelchairs are propelled and steered by the person spinning the wheels with both arms. The muscular motion is very awkward and unnatural. It uses many different relatively undeveloped muscles. The motion of the arms and hands rises as they pull from the back toward the top of the wheel. They push in a forward horizontal motion at the highest point of the wheel. Then push down and forward at the end of the stroke. Steering is done by pushing faster on the opposite wheel to the direction of the turn. Since two functional arms are needed to turn both wheels at the same speed a person with the use of only one arm cannot push or steer a wheelchair.

### Present Devices

All wheelchairs are virtually identical. A chair with a plastic cloth seat and back and metal frame rests two front small wheels on pivoting casters and in back two fixed direction large wheels.

This problem listed above has been addressed by motorized wheelchairs and scooters. They are expensive and heavy.

### SUMMARY

The proposed device uses a straight-back pulling motion of a handle for propulsion. This motion uses two well developed muscles, biceps and triceps. Steering is done with two handles on both sides of the propelling hand. They are similar to bicycle hand brakes which pull on a wire within a cable which closes calipers on a wheel which slows it down. Slowing down one wheel turns the wheelchair in that direction. Closing the calipers on both wheels slows the forward speed of the wheelchair.

### BRIEF DESCRIPTION OF THE DRAWINGS

FIG. 1 is a drawing of the present wheelchair.

FIG. 2 shows the bar which attaches the device to the wheelchair.

FIG. 3 shows the handle which pivots on the above bar.

FIG. 4 shows the cables attached to the handle.

FIG. 5 shows the handle pulling the wire inside the cable.

FIG. 6 shows the retracted wire turning the axle and small wheels.

FIG. 7 shows the small wheels turning the main wheels.

FIG. 8 shows a bracket holding the small wheels against the main wheels.

FIG. 9 shows how the bracket attaches to the wheelchair frame.

FIG. 9A shows the calipers closing on the main wheels.

FIG. 10 shows a two handled variation.

FIG. 11 Shows the steering-braking mechanism on a two-handled variation

FIG. 12 shows an alternate rack and pinion driving mechanism.

### DETAILED DESCRIPTION

This device enables a wheelchair-bound person with only one functional arm to propel the wheelchair by a simple pull straight-back on a handle and to steer or stop by squeezing another handle just to the side.

Wheelchairs made by many different manufacturers are almost identical. This portable device could be adjusted and attached to virtually any existing wheelchair.

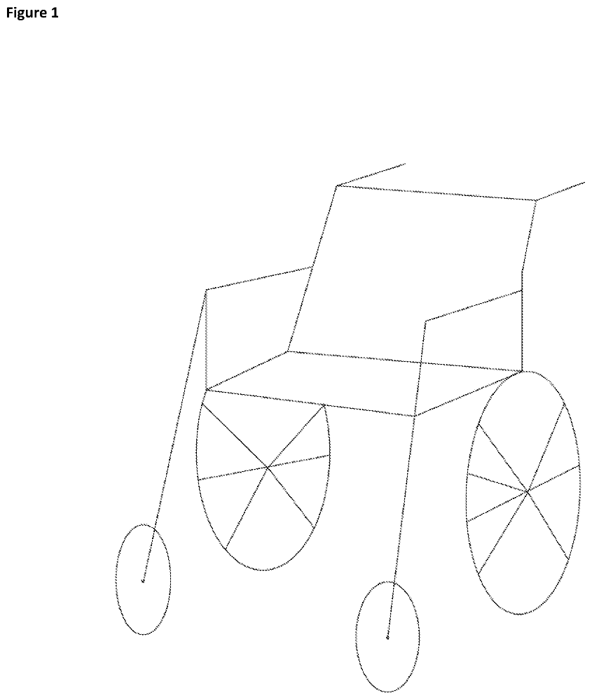

In their simplest description they are a plastic cloth seat and seat back supported and surrounded by a metal frame. Two large wheels rotate around an axle which is attached to the frame. Two small wheels in front pivot on vertical members of the frame. Shown in FIG. 1.

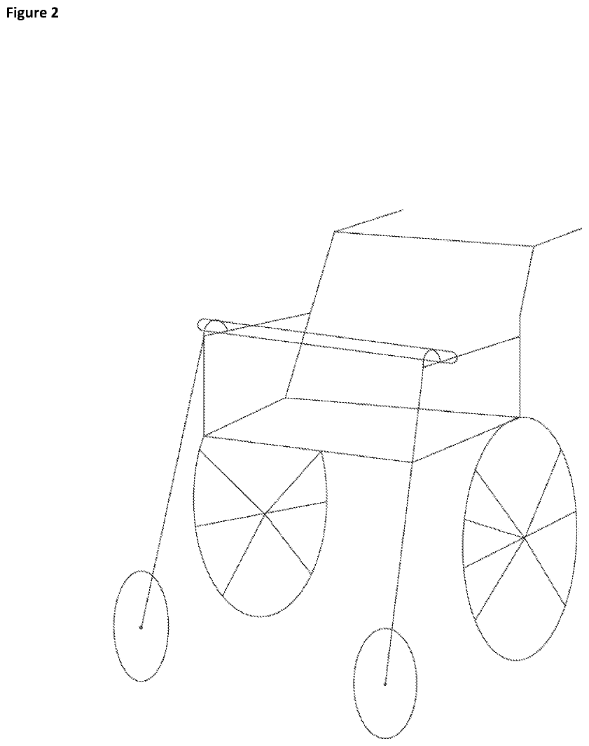

A removable bar attaches to the attaches to the side rails shown in FIG. 2

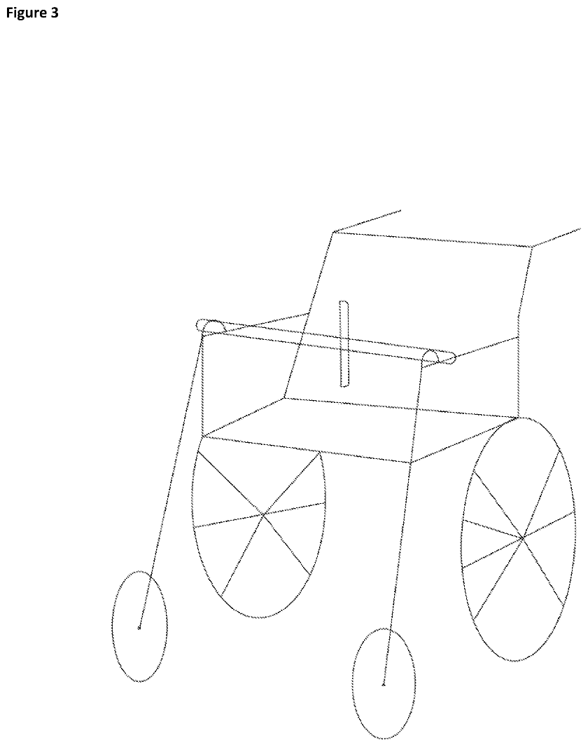

A handle which the occupant can pull toward themselves pivots on the above bar. A ratchet and spring return the handle to its original position when released. FIG. 3.

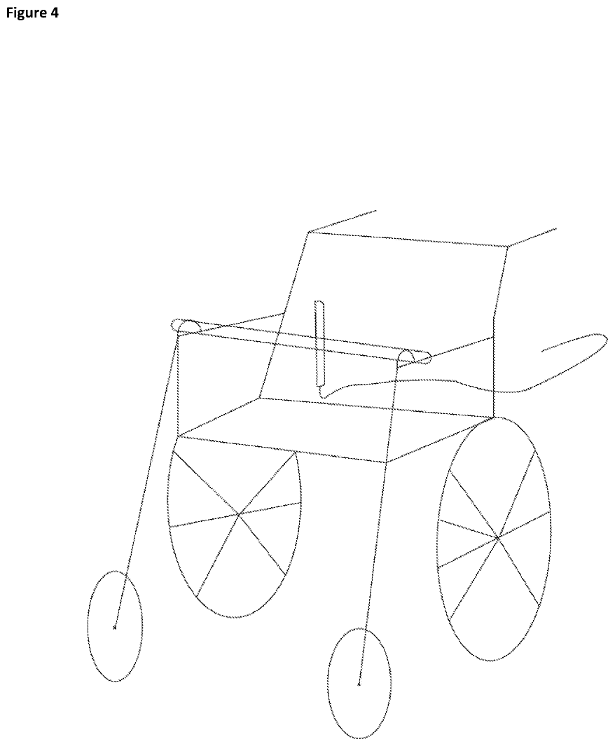

Cables similar to hand brakes on bicycles attach to the bottom of the handle. FIG. 4

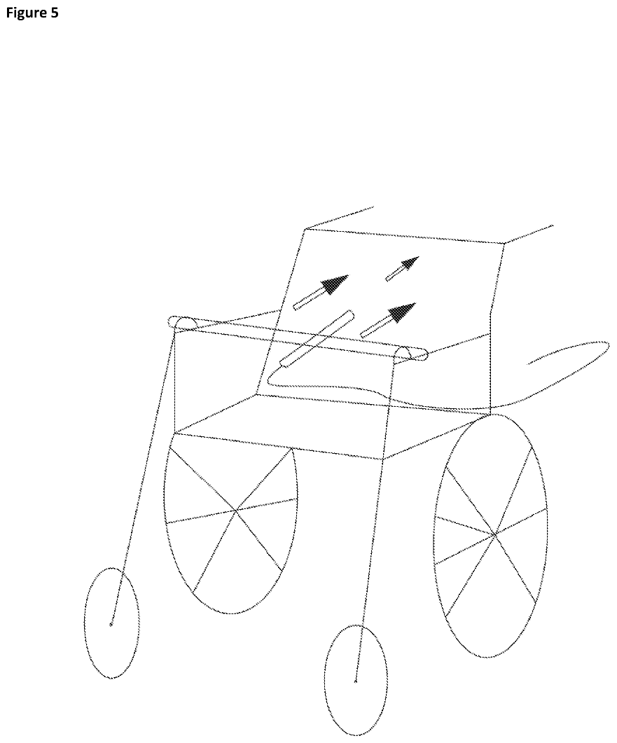

If the occupant pulls back on the handle the wire inside the cable will retract. FIG. 5

The retracted wire through a gear rotates a transverse axle. Previously mentioned ratchet mechanism enables the occupant to rotate the axle only on motion pulling the handle toward themselves.

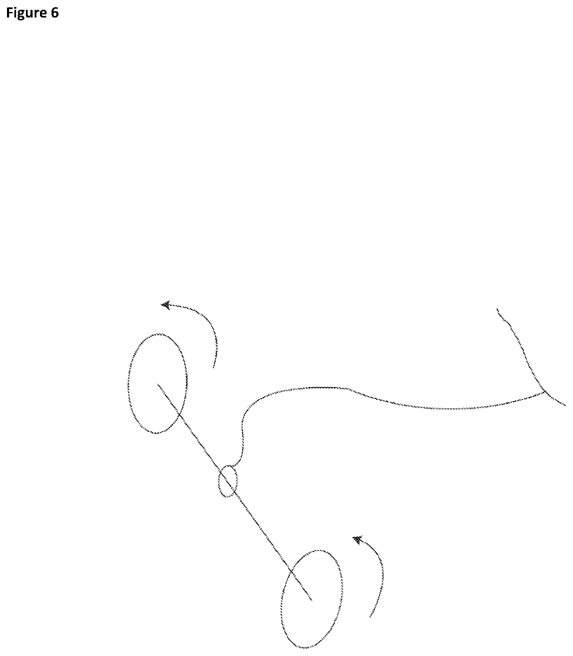

FIG. 6

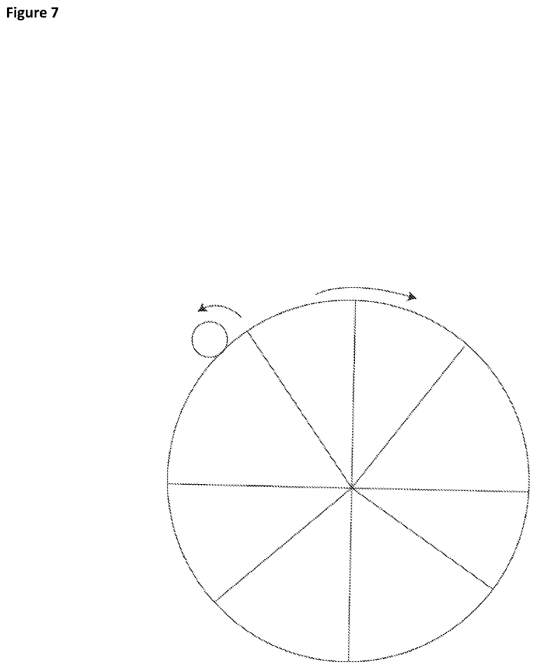

At both ends of the axle are wheels which contact both main wheels of the wheelchair. When the wheels on the end of the axle turn the main wheels of the wheelchair will turn in the opposite direction—propelling the wheelchair forward. FIG. 7

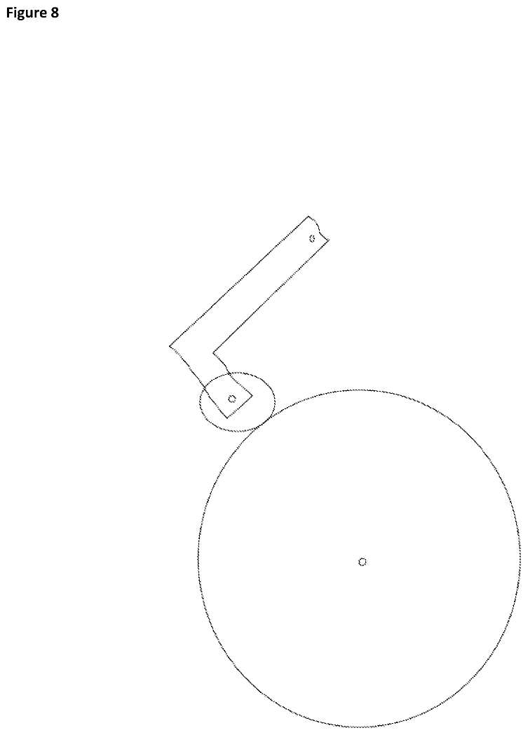

The wheels at the ends of the transverse axle are held in contact with the main wheels by a spring loaded bracket. FIG. 8

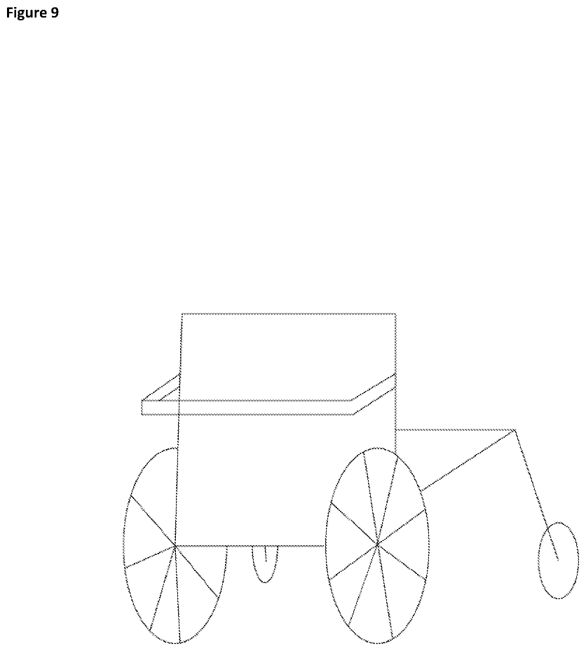

The bracket is held in place to maintain contact by a bar which attaches to the vertical members of the wheelchair frame. FIG. 9

Braking is done by two handles attached to both sides of the propulsion handle Similar to bicycle hand brakes. By squeezing them a wire inside the cable will close the calipers on each main wheel to slow or stop them. FIG. 9A

Steering is done by squeezing only one of the handles. Slowing the velocity of one wheel will turn the wheelchair in that direction.

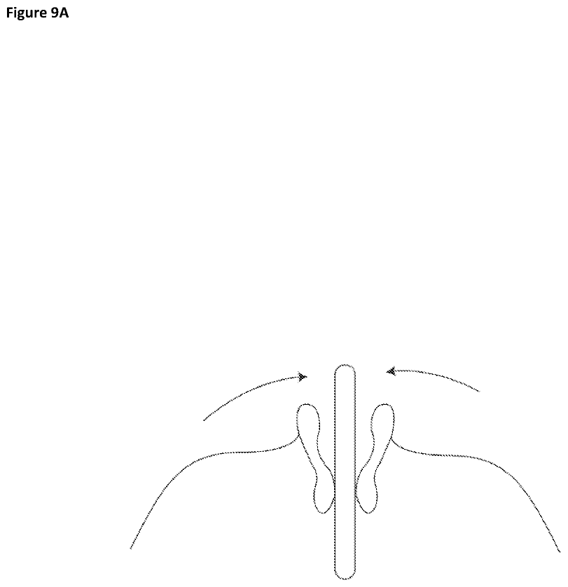

A variation of this device for people with the use of both arms would be attaching two propulsion handles to the front bar. This will enable them to propel their wheelchair with double the strength with a simple pulling motion. FIG. 10

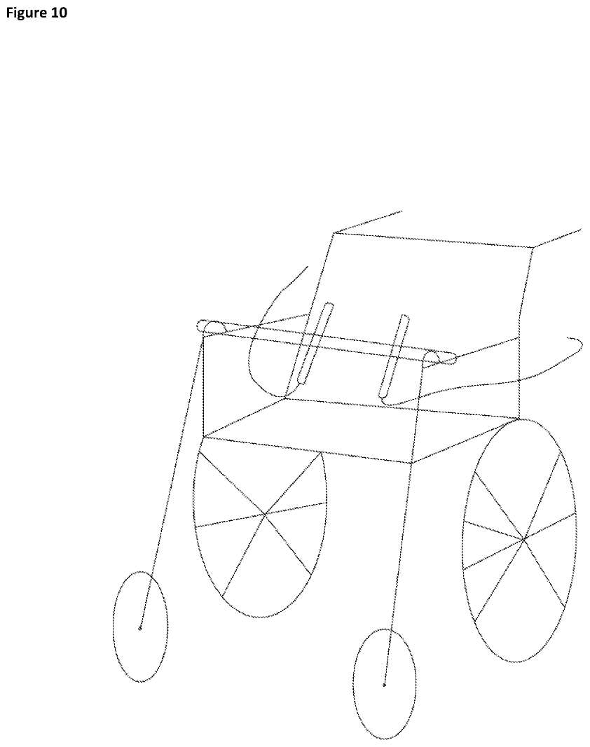

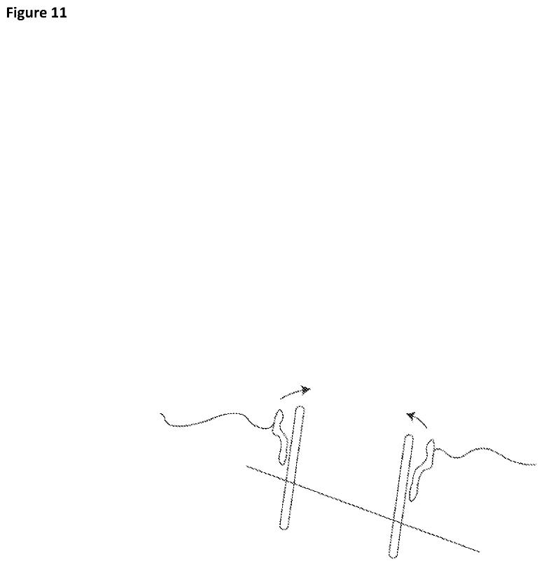

With two propulsion handles one steering handle would be on each side. Each braking handle would be on each side of the propulsion handles. FIG. 11

What is claimed is:

1. A wheelchair propulsion and steering device which can be operated by people with the use of only one arm.

2. A device which can be easily attached to and removed from any existing wheelchair.

3. A variation of which can be used by people with the use of both arms (most users) for a stronger and more natural arm motion to propel and steer the wheelchair.
